(19) United States
(12) Patent Application Publication
(10) Pub. No.: US 2022/0135005 A1
(43) Pub. Date: May 5, 2022

(54) METHOD AND SYSTEM FOR DIVERTING RAM AIR TO VEHICLE SENSORS

(71) Applicant: Argo AI, LLC, Pittsburgh, PA (US)

(72) Inventor: Dustin R. Yautz, Wexford, PA (US)

(21) Appl. No.: 17/084,493

(22) Filed: Oct. 29, 2020

(51) Int. Cl. B60S 1/54; B62D 21/17; B62D 25/16; G01C 21/36; B01D 45/04; B01D 53/26; B01D 46/00

(52) U.S. Cl. CPC B60S 1/54; B62D 21/17; B62D 25/16; B01D 46/003; B01D 45/04; B01D 53/266; G01C 21/36

(57) ABSTRACT

A sensor cooling and cleaning system for a vehicle includes an inlet that is coupled to an air intake of a vehicle body and positioned to receive ram air when the vehicle is in forward motion. The system includes a passive air conditioning device that is configured to remove moisture from the ram air received through the inlet to produce conditioned air. The system also includes an outlet that is positioned adjacent to and upstream of sensor to direct the conditioned air from the passive air conditioning device toward a stagnation point that is located upstream of the sensor, during the forward motion of the vehicle.

### BACKGROUND

This document describes methods and systems that are directed to diverting ram air to clean and/or cool the vehicle sensors.

Most vehicles come equipped with user selectable features, such as convenience features, which when activated, affect the operation of the vehicle to improve the comfort and convenience of driving. For example, a vehicle may include automated cruise control feature. The automated cruise control feature may be provisioned by an automated cruise control radar installed on the vehicle which can be activated at the driver's preference, such as while driving along a highway. In the event that the automated cruise control radar fails, the driver is still able to drive and navigate the vehicle as they would normally but without the added convenience of cruise control feature.

Vehicles are provided with various cameras for providing additionally convenience features to assist a driver, such as for backup assistance or lane changing assistance. However, in the event of failure or deterioration of performance by any of these cameras, the driver is still able to drive and navigate the vehicle as they would normally but without the added convenience of backup assistance or lane-changing assistance. A vehicle may include lane keeping cameras. The lane keeping cameras may utilize the windshield wiper to keep the lens clean. Failure or deterioration of performance by convenience sensors affect the convenience features and not the vehicle's driving performance while driven by a human.

Cameras, radar systems and other sensors are even more important in autonomous vehicles, in which the vehicle's motion planning system must use sensor data to plan a path and operating speed for the vehicle. Failure of an autonomous vehicle's sensors may require the vehicle to exit an autonomous mode and have a human operator take control, or it may require the vehicle to stop in a safe location until the sensor can be addressed.

This document describes a ram air diverting system that helps address these issues.

### SUMMARY

Some embodiments include a sensor cooling and cleaning system for a vehicle that may include an inlet that is coupled to an air intake of a vehicle body and positioned to receive ram air when the vehicle is in forward motion. The system may include a passive air conditioning device that is configured to remove moisture from the ram air received through the inlet to produce conditioned air. An outlet is positioned adjacent to and upstream of sensor mounted to the vehicle body to direct the conditioned air from the passive air conditioning device into a stagnation point, and which may thus divert road spray from the stagnation point. The directed conditioned air diverts the road spray from a stagnation point upstream of the sensor, during the forward motion of the vehicle.

In various embodiments, the passive air conditioning device may include a duct that has a structure to separate droplets from the ram air. The structure may include a bend or a filter.

In various embodiments, the system may further include a duct that includes a first conduit portion that has a first end positioned at the air intake and a second end coupled to the passive air conditioning device and a second conduit portion that has a first end coupled to the passive air conditioning device and a second end coupled to the outlet.

In various embodiments, the system may include a mesh or filter coupled to the second end of the duct or to the air intake.

In various embodiments, the vehicle body may include front wheel wells and rear wheel wells, each wheel well houses a wheel that produces the road spray during the forward motion of the vehicle. The sensor may be positioned downstream a respective one wheel well. The stagnation point may be downstream a respective one wheel well and upstream the sensor.

In various embodiments, the outlet may include a diffuser, a nozzle, or a combination of both.

Some embodiments include an autonomous vehicle including an onboard computing system containing programming instructions that are configured to control navigation of the vehicle. The vehicle may include a vehicle body and a sensor that is on or extending from the vehicle body to collect data and deliver the data to the onboard computing system for use in controlling navigation of the vehicle. The vehicle may include a sensor cooling and cleaning system. The sensor cooling and cleaning system may include an inlet that is coupled to an air intake of the vehicle body and positioned to receive an amount of ram air when the vehicle is in forward motion. The sensor cooling and cleaning system may include a passive air conditioning device that is configured to remove moisture from the ram air received through the inlet to produce conditioned air, and an outlet that is positioned adjacent to and upstream of sensor to direct the conditioned air from the passive air conditioning device into a path of road spray to divert the road spray from a stagnation point upstream of the sensor, during forward motion of the vehicle.

In various embodiments, the vehicle body may include front wheel wells and rear wheel wells. Each wheel well may house a wheel. The vehicle body may include a front fender and the sensor may be mounted in proximity to the front fender and upstream a respective one front wheel well. The stagnation point may be downstream the front fender and upstream the sensor. The road spray during the forward motion of the vehicle may be from another vehicle upstream the front fender or in an adjacent lane.

In various embodiments, the vehicle body may include front wheel wells and rear wheel wells with wheels. The vehicle body may include a rear fender and the sensor may be mounted in proximity to the rear fender.

Some embodiments include a method for cleaning and cooling a sensor of a vehicle including, during forward motion of the vehicle, receiving ram air at an inlet of a cleaning and cooling system that is coupled to an air intake of a vehicle body of the vehicle. The method may include, by the cleaning and cooling system, removing moisture from the ram air to produce conditioned air, and both disrupting a path of debris flowing toward a sensor and cooling the sensor by expelling the conditioned air upstream the sensor through an outlet at a location in a stagnation point upstream of and proximate to the sensor.

### BRIEF DESCRIPTION OF THE DRAWINGS

FIG. 1 is an example ram air diverting system to clean or cool vehicle sensors, according to various embodiments of the present disclosure.

FIG. 2 is an example ram air diverting system installed near a sensor of the vehicle.

FIG. 3 is an example vehicle with the ram air diverting system installed to clean or cool the vehicle sensors on longitudinal sides of the vehicle.

FIG. 4A is an example direction of debris field of road spray from a leading vehicle.

FIG. 4B is an example direction of a debris field from road spray of a leading vehicle of FIG. 4A moving around a vehicle's sensors and being diverted by ram air of a ram air diverting system.

FIG. 5A is an example vehicle with arrows representative of a debris field from revolutions of a vehicle's wheel and other road spray of adjacent vehicles in a dead zone behind the vehicle.

FIG. 5B is an example vehicle with arrows representative of a debris field from revolutions of a vehicle's wheel and other road spray of adjacent vehicles in the dead zone being diverted by conditioned ram air.

FIG. 6 illustrates a system architecture for a vehicle, such as an autonomous vehicle to control at least one autonomous navigation operation;

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

The term “vehicle” refers to any moving form of conveyance that is capable of carrying either one or more human occupants and/or cargo and is powered by any form of energy. The term “vehicle” includes, but is not limited to, cars, trucks, vans, buses, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle. Various components of the vehicle may include automated devices.

This document includes certain terms relating to direction and orientation of a moving vehicle. “Forward” motion refers to motion of a vehicle when its transmission is in a drive mode, as in the direction that a driver would typically face if present in and operating the vehicle. “Downstream” air flow refers to a direction of air flow moving across and/or through a vehicle as the vehicle is moving forward. Thus, a first position is typically “downstream” of a second position if the distance between the first position and the front of the vehicle is greater than the distance between the second position and the front of the vehicle. Conversely, a first position is typically “upstream” of a second position if the distance between the first position and the front of the vehicle is less than the distance between the second position and the front of the vehicle.

Definitions for additional terms that are relevant to this document are included at the end of this Detailed Description.

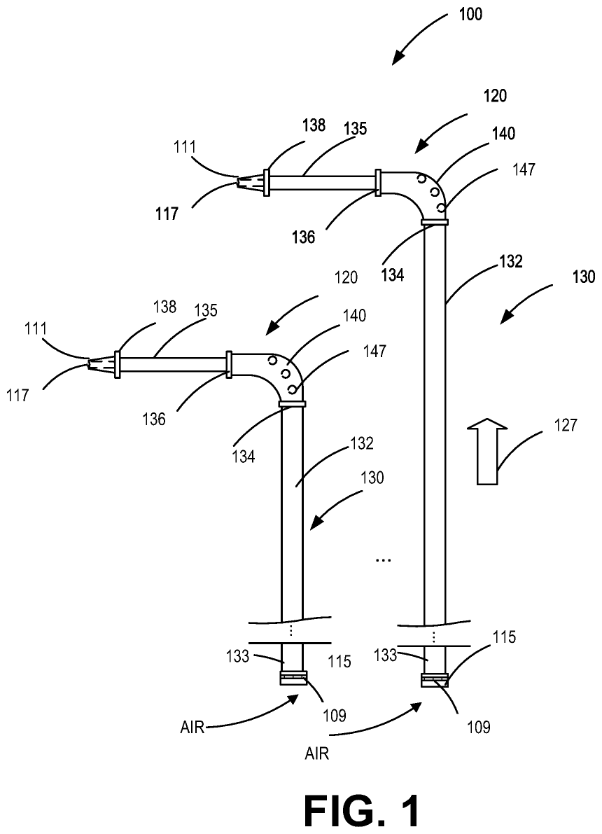

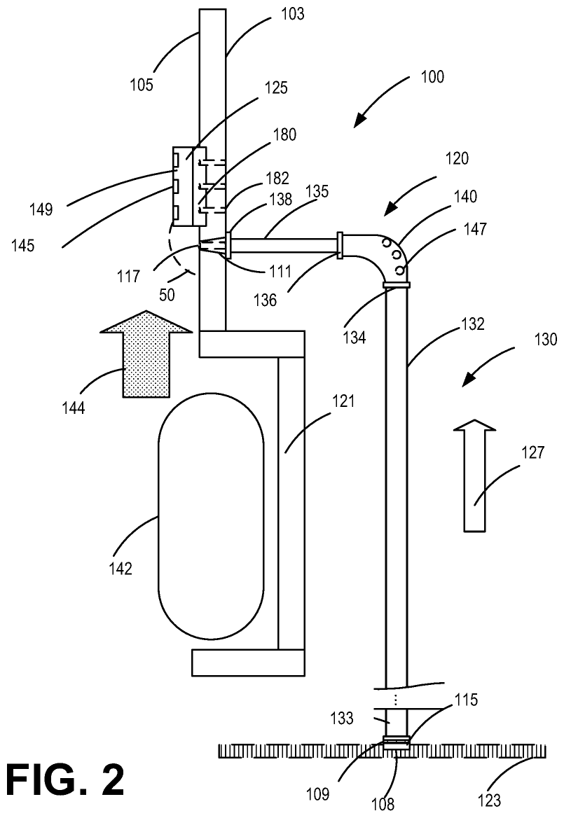

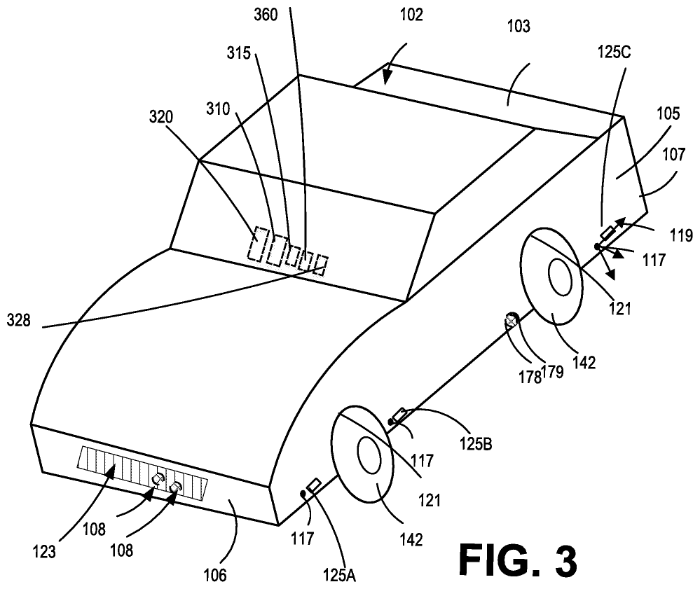

FIG. 1 illustrates an example configuration of a ram air diverting system 100. The system 100 of FIG. 1 will be described in relation to the vehicle 102 (FIG. 3) and vehicle body 103 shown in FIGS. 2-3. FIG. 2 is an example ram air diverting system installed near a sensor 125 of the vehicle. FIG. 3 is an example vehicle with the ram air diverting system installed to clean or cool vehicle sensors 125A, 125B, and 125C on longitudinal sides of the vehicle.

With specific reference to FIGS. 1 and 2, the system 100 may include a ram air inlet 115 coupled to an air intake port 108 of a vehicle body 103 to receive an amount of ram air. The air intake port 108 may be part of a vehicle grill 123, or it may be a port located on another component at or near a forward-facing component of the vehicle, as described in FIG. 3. In some embodiments, an air intake port 108 may be located on a longitudinal side of the vehicle 102.

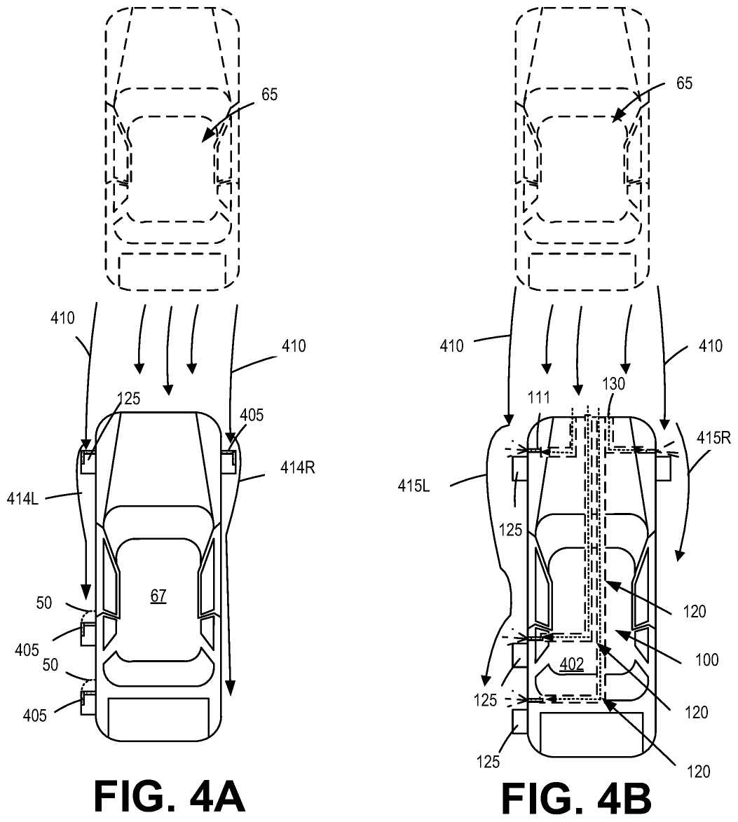

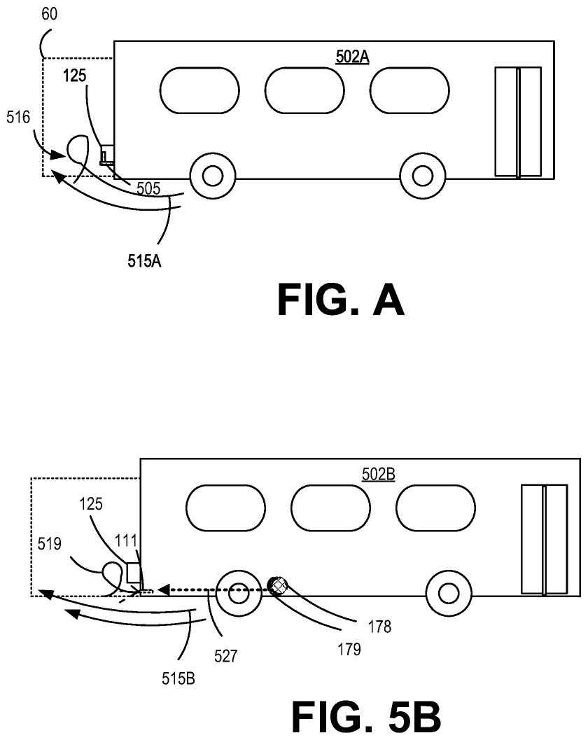

The system 100 may include one or more passive air conditioning device 120 configured to remove moisture from the ram air received through the inlet to produce conditioned air. The system 100 may include an outlet 117 that is positioned and configured to direct, denoted by arrows 119 (FIG. 3), the conditioned air at a location that is upstream and adjacent to a sensor 125 to cool the sensor and/or clean a sensing surface 145 (FIG. 2) of the sensor 125. The location of the outlet 117 serves to divert air and debris flowing in a direction of stagnation point 50 upstream of the sensor 125. The placement of the outlet 117 to improve airfoil or airflow around a sensor will become more evident with the description of FIGS. 4A-4B and 5B. The system 100 may include multiple outlets 117, at least one outlet is for a respective one sensor.

The system 100 further includes one or more ducts 130 that connects the inlet 115 to the outlet 117 via the passive air conditioning device 120. Various embodiments may include multiple inlets and/or multiple outlets to increase the amount of airflow or increase the number of sensors that are impacted.

The duct 130 may include a first conduit portion 132 having a first end 133 positioned at an air intake location of the vehicle 102 and a second end 134 coupled to the passive air conditioning device 120. The duct 130 may include a second conduit portion 135 having a first end 136 coupled to the passive air condition device 120 and a second end 138 coupled to the outlet 117. In various embodiments, the ends 134 and 136 may include connectors to bridge the duct 130 with the structure 140. In other embodiments, the duct 130 is integrated with the structure 140.

The passive air conditioning device 120 includes a structure 140 to separate droplets from the ram air. The structure 140 may include a bend or a filter to separate droplets from ram air so that the received ram air is dried to clean the sensor surface 145, such as without limitation a lens, during movement of the vehicle 102. Alternatively, instead of or in addition to serving as a passive air conditioning device 120, the system may employ active air conditioning equipment for removing moisture from (and thus cooling) the air, such as an evaporator, a compressor and a condenser.

A bend with a drain may be used to filter droplets/particles out using their inertia. On the other hand, a filter may be used to reduce the number of droplets, accumulating them into heavier droplets that can be drained away. Optionally, both a bend and a filter may be employed.

The system 100 may further include a mesh or filter 109 coupled to the first end 133 positioned at an air intake location of the vehicle 102. The mesh or filter 109 may be configured to limit the size of particles capable of entering the first conduit portion 132. For example, mesh or filter 109 may remove heavier particles in the ram air prior to the air reaching the structure 140. The outlet 117 may include a diffuser, a nozzle 111 or a combination of both. The diffuser may be positioned in the second conduit portion 135 before the outlet 117. The nozzle 111 may be configured to concentrate air from the diffuser leading to an orifice of the outlet 117. A filter may be provided at the outlet 117.

The system 100 may be configured to reroute the ram air from the front of the vehicle 102 passing through the vehicle grill 123, for example, to the other parts of the vehicle. The rerouted and conditioned ram air is sent to a diffuser and/or nozzle 111 upstream the sensor or sensor surface to improve flow to and over the protruding sensor housing and it's sensor surface, thereby deflecting lighter particles in the airflow associated with arrow 144, such as without limitation, from the adjacent wheel 142 and preventing a buildup in areas adjacent to stagnation points 50. Assume for the sake of discussion, arrow 144 is a path of debris from road spray of wheel 142 and sometimes may be part of road spray from a vehicle that is in an adjacent lane next to wheel 142, for example. The structure 140 is configured to separate droplets from the ram air so that air contacts and cleans the sensor 125 and/or sensor surface 145 during movement or forward motion of the vehicle 102. During motion of the vehicle, the flow of the conditioned ram air may prevent droplets from getting to and/or remaining on the sensor surface, as described in more detail later.

The inlet 115 can be placed anywhere on the front of the vehicle 102, and ram air received via the inlet may be ducted back to a location in proximity of the sensor 125. A second amount of ram air can be rerouted to a part of the wheel well airflow. The first amount of ram air can be rerouted to the structure 140.

A filter could also be used in the structure 140 or at inlet locations, for example. However, the filter may need to be changed for maintenance purposes. The filter may clog and may cause a pressure drop in the duct 130 to the nozzle 111.

The ram air flows in the direction of arrow 127 as the vehicle 102 travels in a forward motion within duct 130. In some variations, the ram air is conditioned by the structure 140 and expelled in proximity to sensor 125 to cool the sensor having at least one sensor surface 145 exposed to the ambient environment. In some variations, the ram air is conditioned by the structure 140 and expelled in proximity to sensor 125 to clean at least one sensor surface 145. For example, the ram air is conditioned by removing or reducing the moisture of the ram air by the bend, for example, of the structure 140. The droplets of moisture may be drained via outlets 147, shown in phantom. The collected droplets can be easily drained out of the bottom of the duct (if separated out or caused to drop by a change in airflow velocity).

The duct 130 may end in a wide nozzle 111, forward (upstream) of the sensor to break up the stagnation point 50 (FIG. 2) and to deflect or divert smaller particles (mist, small droplets, or small bugs) in the airflow to the sensor's location.

Referring now to FIG. 2, sensor 125 may be mounted via mount assembly 180 to the vehicle body 103. The mount assembly 180 may include a base secured to the vehicle body 103 via fasteners 182. The sensor 125 is a sensor device that may include a sensor housing 149 supporting or housing the at least one sensor surface 145 which is exposed to the ambient environment or air conditions. In various embodiments, the sensor surface 145 may be a sensor lens.

As best seen in FIG. 2, a sensor 125 is mounted in the vehicle body area near front fender 106 (far up on the vehicle) and along longitudinal sides to improve visibility at intersections, as will be described in relation to FIG. 3. In various embodiments, the sensor 125 may be mounted behind the rear wheel or in proximity to the rear fender area near the rear fender 107 (far back on the vehicle) or at other locations, as described in relation to FIGS. 5A-5B. The sensor 125, such as a camera or imaging device, may be mounted in a manner to protrude from the vehicle body 103 in order to improve their field of view. The aerodynamics of the vehicle 102 may be affected the farther out the sensor 125 protrudes from the vehicle body 103. The farther out the sensor 125 protrudes from the vehicle body 103 certain sensor surfaces relied upon for measuring are more exposed to road spray, road spray impacts and stagnation points 50 (preventing droplet removal once impacted). The sensor 125 may include one or more of the following: an ultrasonic sensor, a curb feeler, or camera with a camera lens, for example. As shown in FIG. 2, the leading surface of sensor 125 adjacent to stagnation point 50 is essentially perpendicular to the road spray, denoted by the arrow 144. The outlet 117 expels a conditioned air vector from the ram intake air in a direction which is perpendicular to the airflow of the road spray. Thus, the conditioned air vector may include a stream of conditioned air that is sprayed in a direction that includes at least one stream that is parallel to the ground and perpendicular to the road spray. The conditioned air vector when sprayed may include a stream of conditioned air that is parallel to a leading surface of the sensor. In some embodiments, the conditioned air vector when sprayed may include a stream of conditioned air that is angled toward a leading surface of the sensor, including in moving conditioned air over a sensor surface (i.e., sensor lens). In some embodiments, the conditioned air vector when sprayed may include a stream of conditioned air that is angled toward (in an opposite direction of) the airflow of the road spray.

Ram air that is directed to vehicle sensors using systems such as those described shown above may help to keep the sensors cool by reducing the temperature of air that is proximate to the sensors. Ram air directed to sensors as described above can also help keep the sensors clean, especially if filters are used in the system, as the clean air will be pressurized due to vehicle motion and can thus help blow dirt and debris away from the sensors.

The stagnation points 50 or stagnation zones do not benefit from airflow to remove droplets or particles. Instead, a sensor or other object downstream the stagnation points 50 benefit from cleaning of a sensor surface or other object surface by diverting a path of debris in the airflow of the road spray farther away from the sensor.

Referring also to FIG. 3, the system 100 may be configured to be installed in a vehicle 102 (FIG. 3) having a vehicle body 103 (FIG. 2) with one or more sensors 125 (FIG. 2) having at least one sensor surface 145 (FIG. 2) directly exposed to the ambient environment. In FIG. 3, three sensors 125A, 125B and 125C are shown mounted to a longitudinal side of the vehicle 102 and exposed to the ambient environment or ambient air conditions. It should be understood, that the vehicle 102 can have many sensors distributed about the vehicle body 103 to sense ambient conditions from the longitudinal sides, front and rear of the vehicle. The various embodiments described herein are directed to those sensors along the sides and rear which are near stagnation points 50 (FIG. 2) on the vehicle 102.

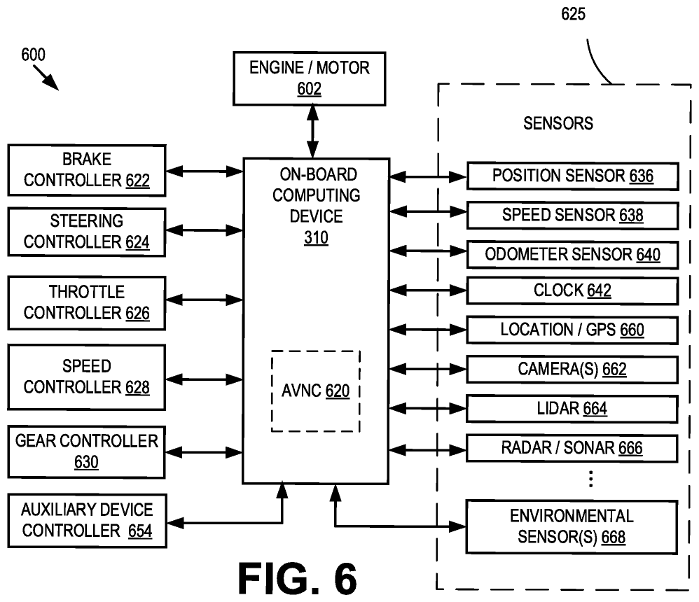

In the example shown, each sensor surface 145 (FIG. 2) may protrude from the exterior surface 105 or longitudinal side of the vehicle 102. Alternatively, in various embodiments, any sensor surface 145 may be flush with an exterior surface 105 of the vehicle 102. The sensors 125 may be used to provide data for modifying at least one autonomous navigation operation, for example. Examples of sensors are described in relation to FIG. 6.

The vehicle body 103 may have a known a stagnation point 50 (FIG. 2) relative to an installation location of a sensor 125. For example, a stagnation point 50 may be downstream of a wheel well 121 housing a vehicle wheel 142 but upstream of a sensor 125. During forward motion of the vehicle, debris from road spay from the wheels of the vehicle 102 or other vehicles, in adjacent lanes or leading the vehicle 102, may collect in the stagnation point or on surfaces of the sensor, such as those adjacent to the stagnation point.

Stagnation points may generally form where there is a relatively flat surface perpendicular to the airflow. From an aerodynamic perspective, an example of a stagnation point is downstream of the wheel well where the sensor protrudes into the airflow from a wheel of the vehicle 102. According, a wheel in a wheel well is a potential source of road spray. However, the primary source of road spray can also be from lead vehicles or adjacent vehicles. Weather conditions, such as without limitation, wind may contribute to road spray.

As shown in FIG. 2, since road spray of a vehicle's wheel 142 alone, adjacent vehicles, or in combination is one source of road spray, the arrow 144 is denoted with dotted hatching, moving in the direction of a stagnation point 50 adjacent to and upstream a sensor 125. A leading vehicle may be a provider of road spray, as well. An object of the embodiments is a change in the aerodynamics of the vehicle to minimize road spray from impacting the sensor 125. The arrow 144 is depicted as generally perpendicular to a surface of the sensor 125.

In various embodiments, the outlets 117 of FIG. 3 may be positioned and configured to direct the conditioned air into a stagnation point 50 of the vehicle body 103 or region that would otherwise become a stagnation point to disrupt a path of debris or road spray moving through the stagnation point 50 and toward a sensor surface 145 during movement (such as forward motion) of the vehicle 102. The outlet 117 may be added at a location on the vehicle body to provide an additional conditioned air vector to a region in order to redirect the airflow around a sensor surface. The conditioned air vector is an airflow vector created from the ram air. It should be understood, that the disclosure has application to be applied to any region or location on the vehicle that would benefit from adding an additional airflow vector to the region in order to redirect the airflow vector around a sensor surface of a sensor. Such as region or location may otherwise become a stagnation point on the vehicle in various embodiments.

The conditioned air vector being output from outlet 117 prevents/mitigates the number of droplets/particles in road spray, for example, on the sensor lens at any given time. When a sensor 125 is exposed to airflow that contains road spray, the droplets may make contact with the sensor lens; and if the force of the conditioned air vector is high enough, the droplets are blown away by the conditioned air vector. Droplets/particles can also reach stagnation points or zones because droplets/particles have more mass and do not change directly as easily as the airflow. The difference is that without a direct conditioned air vector moving over the surface of the lens in the stagnation zone, the droplets/particles cannot be removed or cleaned away.

In FIG. 3, the air intake port 108 is shown as being connected or formed in the vehicle grill 123. The system 100 may use one intake port 108 for all outlets 117 or multiple intake ports 108. Other air intake ports 178 on a longitudinal side of the vehicle may be included in system 100. Intake port 178 may be connected to its own passive air conditioning device 120 and duct 130. In some embodiments, the intake port 178 may have a deflector 179 connected to the intake port 178 to deflect air from the airflow and deflect such air to the intake port 178. Is should be understood, that one or more outlets 117 may share a single intake port 108 or 178.

In various embodiments, system 100 changes the vehicle aerodynamics to 1) remove/minimize stagnation zones, as well as 2) modify the vehicle aerodynamics to direct the less massive particles (lighter particles) away from the sensor or sensor lens.

In various embodiments, an advantage of the system 100 is to minimize the number of droplets/particles on the sensor surface or lens at any given time. When a sensor 125 is exposed to airflow that contains road spray, the droplets make contact with the lens and then are blown away, if the airflow is high enough. Droplets/particles can also reach stagnation zones (areas without the air is stagnant) because droplets/particles have more mass and do not change directly as easily as the airflow containing road spray. The difference is that without direct airflow over the surfaces in the stagnation zone, the droplets/particles may not be removed.

When a vehicle moves along a road, dirt, debris, and moisture will adhere to the wheel and then spray upward toward the vehicle body of the vehicle, as well as toward vehicles behind the vehicle or in adjacent lanes. Road spray tends to accumulate the most in the following locations: the lower grill, the fender, and behind the wheel well. Road spray may accumulate on any object (i.e., sensor 125) that is in the direct path of the airflow around the vehicle or in areas of turbulence, where particles may be lifted from the road surface. The road spray includes, but is not limited to any object that is placed on or protrudes from the side of the vehicle. By way of non-limiting example, road spray may accumulate on the side-view mirrors, door handles, and externally mounted sensors.

The road spray may be caused by wheels 142 rolling along the road whether from vehicle 102 or other vehicles, such as without limitations, vehicles in adjacent lanes or a leading vehicle in the same lane of vehicle 102. However, in various embodiments, the placement of the outlet 117 is configured to cause a change in the aerodynamics of the vehicle 102 to minimize road spray from impacting the sensor 125 or other objects.

When a vehicle moves along a road, air will be received into the vehicle's front end. Most vehicles are equipped with a ram air intake, which specifically uses the air pressure that is generated by the vehicle's motion to direct air to the vehicle's engine intake manifold. However, any air that is forced to enter into an aperture of the vehicle due to the vehicle's motion may be referred to as ram air.

The amount of road spray that a vehicle receives typically increases with speed. The amount of ram air that a vehicle may receive also typically increases with the speed of the vehicle.

The vehicle body 103 includes wheel wells 121, such as front wheel wells and rear wheel wells. A wheel well 121 may have a stagnation point 50 that may be downstream of a respective one wheel well 121 but upstream of a sensor 125. (In this description, “upstream” and “downstream” refer to the direction of airflow while the vehicle is moving forward. Thus, upstream is typically relatively closer to the front of the vehicle, while downstream is typically relatively closer to the rear of the vehicle.)

The description of FIGS. 1 and 2 herein describe a system 100 with a single passive air conditioning device 120 and duct 130, shown. However, the vehicle body 103 may incorporate multiple passive air conditioning device 120 and duct 130 combinations, such as one for each camera or sensor being mounted to a lower part of the vehicle that may need cooling or cleaning of a sensor surface.

According to various embodiments, the vehicle 102 may include an on-board computing device 310 for an autonomous vehicle driving, as shown in FIG. 3. The on-board computing device 310 may control one or more of a braking system (not shown), engine/motor 602 (FIG. 6), and steering system (not shown) of the vehicle 102 in response to at least one control signal representative of the classification state. Suitable braking systems, engine systems and steering systems include, but are not limited to, those well known in the art.

The on-board computing device 310 is configured to carry autonomous driving functions. Some of the components of on-board computing device 310 may include programming instructions to carry out the functions described herein which may be executed by processor 605 (FIG. 6) or processor 328.

The vehicle 102 may include a computer vision system 315 incorporated into the vehicle 102 configured to receive a digital image of the environment. The computer vision system 315 may include one or more cameras, such as sensor 125, for capturing digital images of various features of the environment in which the vehicle 102 is traveling. Each camera includes a field of view (FOV).

The vehicle 102 may include a geographic location system (GLS) 360 configured to determine a location and orientation of the vehicle 102. The GLS 360 may include a Global Positioning System (GPS) device. It is noted, however, that other forms of geographic location may additionally, or alternatively, be used. The GLS 360 may be incorporated into the vehicle 102.

The vehicle 102 may further include a transceiver 320 incorporated in the vehicle 102 and being configured to send and receive digital information from a remote server (not shown) via a wired and/or wireless connection such as, for example, through the cloud, where the vehicle 102 and the remote server are in electronic communication with each other.

The vehicle 102 may further include a processor 328. It is noted that the processor 328 may be a standalone processor or the vehicle's processor. Data processed by the processor 328 may be data received from the vehicle 102, received from the remote server, and/or a combination of data from the vehicle 102 and the remote server. However, for the sake of illustration, the processor 328 is represented incorporated in the vehicle 102. The vehicle 102 may include a standalone processor (e.g., processor 328) and/or at least one separate vehicle processor.

Based on the description provided herein, the system 100 is a sensor cleaning and cooling system that employs passive components using one or more duct conduits to divert ram air to different sensor locations to modify the aerodynamics of the vehicle such that the road spray airflow is directed away from the sensor surface and cause a disruption in a path of debris in the airflow flowing from the vehicle's wheel and other vehicles and toward a sensor surface.

FIG. 4A is an example direction of a debris field of road spray a leading vehicle. The debris field is shown moving around a vehicle's sensors on longitudinal sides. In FIG. 4A, the leading vehicle 65 produces airflow with road spray in the direction of arrows 410, for example. The trailing vehicle 67 is shown with one or more sensors 125 radiating from the longitudinal sides of vehicle 67 which protrude therefrom. Vehicle 67 does not include system 100. This creates stagnation points 50 along surfaces that are generally perpendicular to the airflow of arrows 410. A buildup may form at location 405 denoted as hatched areas, for example. As the airflow of arrows 410 impact sensors 125, the airflow moves around the sensors 125 along representative arrows 414L and 414R. The arrows 414L represent the debris field flowing around the vehicle body, impacting each of the sensors 5, for example, and creating a buildup at location 405. It should be understood, the buildup at location 405 is for illustrative purposes only and should not be limiting in any way. The arrow 414R moves around the sensor 125 in the right, front area of the vehicle; and after passing the sensor 125 on the right the air flows along the side of the vehicle, for example.

FIG. 4B is an example direction of a debris field from road spray of a leading vehicle 65 of FIG. 4A moving around a vehicle's sensors 125 of vehicle 402 and being diverted by ram air of a ram air diverting system 100 (FIG. 1). The system 100 in the vehicle 402 has one or more passive air conditioning device 120 and one or more ducts 130, shown in dashed lines. A duct 130 is shown terminating at nozzle 111 to output or expel a conditioned air vector created from ram air entering the duct 130. The dotted line arrows within the passive air conditioning device 120 represents the ram air. After the bend in the passive air conditioning device 120, the ram air is conditioned, as described above in relation to FIGS. 1 and 2.

As the airflow of arrows 410 intersect with the conditioned air vector from nozzle 111 upstream of sensors 125, the airflow with road spray is diverted around the sensors 125 along representative arrows 415L and 415R. It should be understood, that the number of sensors on any longitudinal side of vehicle 402 is not limited in any way to the operation of system 100 (FIG. 1). The arrow 415L is diverted away from the stagnation point 50 (FIG. 4A). The air and road spray traveling along arrow 415L will again move around sensor 125 but at a distance farther away from the sensor as compared to the air and debris flow of arrow 414L in FIG. 4A, by the expelled spray from nozzle 111.

FIG. 5A is an example vehicle 502A with arrows representative of a debris field, denoted by arrow 515A, from revolutions of a vehicle's wheel and other road spray of adjacent vehicles that may flow into a dead zone 60, denoted by a dashed box, behind the vehicle 502A. A buildup may form at location 505 denoted as hatched areas, for example, on sensor 125 located at a rear location of the vehicle 502A. As the debris field of arrows 515A flows into the dead zone and impacts sensor 125, the airflow of the debris field 515A may loop or coil, as represented by loop 516. This debris field of arrow 515A is filled with a combination of air, particulates from road spray, and moisture droplets.

FIG. 5B is an example vehicle 502B with arrows representative of a debris field denoted by arrow 515B from revolutions of a vehicle's wheel and other road spray of adjacent vehicles that is diverted from the sensor 125 by the spray from nozzle 111. The spray is conditioned air 519. The expelled conditioned air 519 may also form a loop around the sensor 125 in the dead zone 60. However, the conditioned air 519 may be filtered air with moisture droplets removed and/or reduced in size.

In FIG. 5B, the vehicle 502B has a ram air diverting system 100 (FIG. 1) installed. The ram air may be received through air intake port 178 on a longitudinal side of the vehicle 502B. The ram air passes through the system 100 (FIG. 1), is conditioned and then passed through a nozzle 111. The ram air is represented by the dashed line 527 originating at the air intake port 178 and terminating at nozzle 111. A stagnation point may also exist under the sensor 125, for example, or at other locations around the sensor 125.

The nozzle 111 of system 100 (FIG. 1) is positioned at a location under the sensor 125 and may be oriented generally horizontal or parallel to the ground below a bottom surface of the sensor 125. This location is in or adjacent to the dead zone 60 the stagnation point relative to the sensor and the airflow in the direction of arrows 515B.

FIG. 6 illustrates a system architecture 600 for a vehicle 102, such as an autonomous vehicle. The vehicle 102 may include an engine or motor 602 and various sensors 625 for measuring various parameters of the vehicle and/or its environment. Operational parameter sensors 625 that are common to both types of vehicles include, for example: a position sensor 636 such as an accelerometer, gyroscope and/or inertial measurement unit; a speed sensor 638; and an odometer sensor 640. The vehicle 102 also may have a clock 642 that the system architecture 600 uses to determine vehicle time during operation. The clock 642 may be encoded into the vehicle on-board computing device 310, it may be a separate device, or multiple clocks may be available.

The vehicle 102 also may include various sensors 625 that operate to gather information about the environment in which the vehicle is traveling. These sensors may include, for example: a location sensor 660 such as GLS 360 or a GPS device; object detection sensors such as one or more cameras 662; a light detecting and ranging (LIDAR) sensor system 664; and/or a radar and/or a sonar system 666. The sensors 625 also may include environmental sensors 668 such as a precipitation sensor and/or ambient temperature sensor. The sensors 625 may be provide data used by the on-board computing device 310 for determining at least one autonomous navigation operation. The object detection sensors may enable the vehicle 102 to detect objects that are within a given distance or range of the vehicle 102 in any direction, while the environmental sensors collect data about environmental conditions within the vehicle's area of travel. The system architecture 600 will also include one or more cameras 662 for capturing images of the environment. As should be understood, one or more of the sensors 625 may be part of the vehicle but still necessary for autonomous control of the navigation of the vehicle. Additionally, it should be understood, that the sensors 625 may include additional sensors that are not disclosed herein. The vehicle may include other sensors (not shown) such as convenience sensors to equipping the vehicle with those convenience features to aid a human driver.

The on-board computing device 310 (FIG. 1) may include an autonomous vehicle navigation controller (AVNC) 620 configured to control the navigation of the vehicle along a planned route in response to real-time information from the various sensors 625. During operations, information is communicated from the sensors 625 to the autonomous vehicle navigation controller 620 of the on-board computing device 310. The autonomous vehicle navigation controller 620 analyzes the data captured by the sensors and optionally controls operations of the vehicle based on results of the analysis. For example, based on the analysis, the autonomous vehicle navigation controller 620 may cause the on-board computing device 310 to control one or more of: braking via a brake controller 622; direction via a steering controller 624; speed and acceleration via a throttle controller 626 (in a gas-powered vehicle) or a motor speed controller 628 (such as a current level controller in an electric vehicle); a differential gear controller 630 (in vehicles with transmissions); and/or other controllers such as an auxiliary device controller 554. The on-board computing device 310 may store programming instructions in memory or data stores (not shown).

Geographic location information may be communicated from the location sensor 660 to the on-board computing device 310, which may then access a map of the environment that corresponds to the location information to determine known fixed features of the environment such as streets, buildings, stop signs and/or stop/go signals. Captured images from the cameras 662 and/or object detection information captured from sensors such as a LiDAR system 664 is communicated from those sensors) to the on-board computing device 310. The object detection information and/or captured images may be processed and analyzed by the autonomous vehicle navigation controller 620 to detect objects in proximity to the vehicle 102 such as for collision avoidance. In addition or alternatively, the vehicle 102 may transmit any of the data to a remote server system for processing. Any known or to be known technique for making an object detection based on sensor data and/or captured images can be used in the embodiments disclosed in this document. Other sensors may include curb feelers or curb detectors.

The vehicle 102 may need more sensors to improve the autonomous operation of the vehicle. Theses sensors may not be resilient to road debris and mounted in areas that currently do not having a cleaning solution. The system 100 (FIG. 1) described herein is configured to save energy since it employs passive components for performing cleaning and cooling of the sensor surface. The system 100 minimizes power consumption, especially in electric vehicles. The system 100 can have a much lower failure of occurrences because there are no moving parts or electrical components that have operational temperature limitations. The system 100 also does not require power or communication signals between the vehicle and other components to perform the cleaning and cooling. The system 100 derives the source of air based on the motion of the vehicle.

The above-disclosed features and functions, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

Terminology that is relevant to the disclosure provided above is described below.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The terms “memory,” “memory device,” “data store,” “data storage facility” and the like each refer to a non-transitory device on which computer-readable data, programming instructions or both are stored. Except where specifically stated otherwise, the terms “memory,” “memory device,” “data store,” “data storage facility” and the like are intended to include single device embodiments, embodiments in which multiple memory devices together or collectively store a set of data or instructions, as well as individual sectors within such devices.

In this document, when terms such “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

The above-disclosed features and functions, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

1. A sensor cooling and cleaning system for a vehicle, the system comprising:
an inlet that is coupled to an air intake of a vehicle body and positioned to receive ram air when the vehicle is in forward motion;
a passive air conditioning device that is configured to remove moisture from the ram air received through the inlet to produce conditioned air; and
an outlet that is positioned adjacent to and upstream of sensor to direct the conditioned air from the passive air conditioning device toward a stagnation point that is located upstream of the sensor, during the forward motion of the vehicle.

2. The system of claim 1, wherein:
the passive air conditioning device comprises a duct that has a structure to separate droplets from the ram air; and
the structure includes a bend or a filter.

3. The system of claim 1, further comprising a duct that includes:
a first conduit portion that has a first end positioned at the air intake and a second end coupled to the passive air conditioning device; and
a second conduit portion that has a first end coupled to the passive air conditioning device and a second end coupled to the outlet.

4. The system of claim 3, further comprising a mesh or filter coupled to the second end of the duct or to the air intake.

5. The system of claim 1, wherein:
the vehicle body comprises front wheel wells and rear wheel wells, each wheel well housing a wheel that produces road spray during the forward motion of the vehicle;
the sensor is positioned downstream of a respective one wheel well;
the stagnation point is downstream of a respective one wheel well and upstream of the sensor; and
during the forward motion, the conditioned air will divert the road spray from the stagnation point.

6. The system of claim 1, wherein the outlet comprises:
a diffuser;
a nozzle; or
a combination of both.

7. An autonomous vehicle, comprising:
an onboard computing system containing programming instructions that are configured to control navigation of the vehicle;
a vehicle body;
a sensor that is on or extending from the vehicle body to collect data and deliver the data to the onboard computing system for use in controlling navigation of the vehicle; and
a sensor cooling and cleaning system comprising:
an inlet that is coupled to an air intake of the vehicle body and positioned to receive an amount of ram air when the vehicle is in forward motion,
a passive air conditioning device that is configured to remove moisture from the ram air received through the inlet to produce conditioned air, and
an outlet that is positioned adjacent to and upstream of sensor to direct the conditioned air from the passive air conditioning device into a stagnation point that is upstream of the sensor, during forward motion of the vehicle.

8. The vehicle of claim 7, wherein:
the passive air conditioning device comprises a duct that has a structure to separate droplets from the ram air; and
the structure comprises a bend or a filter.

9. The vehicle of claim 7, wherein the sensor cooling and cleaning system further comprises a duct that includes:
a first conduit portion that has a first end positioned at the air intake and a second end coupled to the passive air conditioning device; and
a second conduit portion that has a first end coupled to the passive air conditioning device and a second end coupled to the outlet.

10. The vehicle of claim 9, wherein the sensor cooling and cleaning system further comprises a mesh or filter coupled to the second end of the duct or to the air intake.

11. The vehicle of claim 7, wherein:
the vehicle body comprises front wheel wells and rear wheel wells, wherein each wheel well houses a wheel that produces road spray during the forward motion of the vehicle;
the sensor is positioned downstream of a respective one wheel well; and
the stagnation point is downstream of a respective one of the wheel wells and upstream of the sensor; and
during the forward motion, the conditioned air will divert the road spray from the stagnation point.

12. The vehicle of claim 7, wherein the outlet comprises:
a diffuser;
a nozzle; or
a combination of both.

13. The vehicle of claim 11, wherein:
the vehicle body comprises front wheel wells and rear wheel wells, wherein each wheel well houses a wheel;
the vehicle body comprises a front fender;
the sensor is mounted in proximity to the front fender and upstream a respective one front wheel well;
the stagnation point is downstream the front fender and upstream the sensor; and
the road spray during the forward motion of the vehicle is from another vehicle upstream the front fender or in an adjacent lane.

14. The vehicle of claim 7, wherein:
the vehicle body comprises front wheel wells and rear wheel wells, wherein each wheel well houses a wheel;
the vehicle body comprises a rear fender; and
the sensor is mounted in proximity to the rear fender.

15. A method for cleaning and cooling a sensor of a vehicle comprising, during forward motion of the vehicle:
receiving ram air at an inlet of a cleaning and cooling system that is coupled to an air intake of a vehicle body of the vehicle;
by the cleaning and cooling system, removing moisture from the ram air to produce conditioned air; and
by the cleaning and cooling system, both disrupting a path of debris flowing toward a sensor and cooling the sensor by expelling the conditioned air upstream of the sensor through an outlet at a location in a stagnation point that is upstream of and proximate to the sensor.

16. The method of claim 15, wherein:
the cleaning and cooling system comprises a structure that has a bend or a filter; and
the method comprises, when removing the moisture, separating droplets from the ram air by the structure.

17. The method of claim 15, wherein the cleaning and cooling system comprises a duct that includes:
a first conduit portion that has a first end positioned at the air intake and a second end coupled to the passive air conditioning device, and
a second conduit portion that has a first end coupled to the passive air conditioning device and a second end coupled to the outlet.

18. The method of claim 17, wherein:
the cleaning and cooling system comprises further comprises a mesh or filter coupled to the second end of the duct or to the air intake; and
the method further comprises filtering the ram air such that the conditioned air includes filtered ram air.

19. The method of claim 15, wherein:
the vehicle body comprises front wheel wells and rear wheel wells, each wheel well housing a wheel; and
the stagnation point is downstream a respective one wheel well.

20. The method of claim 15, wherein the outlet comprises:
a diffuser;
a nozzle; or
a combination of both.
